(19) United States
(12) Patent Application Publication
(10) Pub. No.: US 2025/0305891 A1
(43) Pub. Date: Oct. 2, 2025

(54) MEASURING TEMPERATURE OF PHOSPHORESCENT MATERIAL USING A DUAL ELEMENT LIGHT EMITTING DIODE

(71) Applicant: Powell Electrical Systems, Inc., Houston, TX (US)

(72) Inventors: William Marshall Mauney, JR., Houston, TX (US); Alexander Andreas Bartels, Houston, TX (US); Charles Pestell, Houston, TX (US)

(21) Appl. No.: 19/096,982

(22) Filed: Apr. 1, 2025

Related U.S. Application Data
(60) Provisional application No. 63/573,179, filed on Apr. 2, 2024.

(51) Int. Cl. G01K 11/14

(52) U.S. Cl. CPC G01K 11/14

(57) ABSTRACT

A system and method for measuring a temperature of phosphorescent material, which may be applied to a surface of a material whose temperature needs to be measured or integrated within a material enabling the measurement of the temperature within the material. A first light emitting diode element of a multiple element light emitting diode is configured to output a first wavelength to excite the phosphorescent material. A second light emitting diode element of the multiple element light emitting diode is configured to detect an emission from the excited phosphorescent material at a second wavelength, where the first wavelength is at a different wavelength than the second wavelength. The first wavelength may correspond to a peak absorption intensity of the phosphorescent material and the second wavelength may correspond to a peak emission intensity of the phosphorescent material.

### TECHNICAL FIELD

The present disclosure relates generally to phosphor thermometry, and more particularly to measuring the temperature of phosphorescent material using a dual element light emitting diode.

### BACKGROUND

Phosphor thermometry is an optical method for surface temperature measurement. The method exploits luminescence emitted by phosphorescent material (“phosphors”). Phosphors are inorganic chemical compounds or mixtures which may be stimulated by any of a variety of means to luminesce, i.e., emit light. Certain characteristics of the emitted light change with temperature, including brightness, color, and afterglow duration. The latter is most commonly used for temperature measurement, where the longer the afterglow of the phosphor material, the higher its temperature. For example, phosphorescent material may be applied to the surface of a material where the temperature needs to be measured. In another example, phosphorescent material may be integrated in a material, such as being integrated in a thermal barrier coating, thereby enabling the measurement of the temperature within the material.

Certain phosphorescent materials show clear quantifiable changes in behavior that are related to temperature. Of particular interest is the fact that phosphorescent materials emit radiant energy in or near the visible spectrum when excited by an external energy source and will continue to radiate for a period of time after the excitation energy is removed. Such a phosphorescent effect is used in a wide range of commercial and industrial applications, such as in lighting systems.

As discussed above, when the excitation energy is removed, the luminescence will persist for a characteristic time, steadily decreasing. The time required for the brightness to decrease to 1/e (where e corresponds to Euler's number) of its original value is known as the decay time or lifetime, which is signified as τ. This decay rate has been shown to be related to temperature for certain materials, such as magnesium fluorogermanate (Mg₄FGeO₆), an example of phosphorescent material. A number of commercially available sensing and monitoring products make use of this phenomenon to sense and measure temperature in locations and environments where more traditional measurement technologies may not be usable for a variety of reasons.

The energy that is radiated from phosphorescent material is specific to the phosphor compound and is generally restricted to a very narrow wavelength range for a specific phosphor compound. Hence, the selection of the phosphorescent material determines both the energy characteristics of the system and the output wavelength or color. As an example, using magnesium fluorogermanate as the phosphorescent material, the phosphorescent material will emit a very narrow band of energy centered at 655 nm, which is in the red region of the visible spectrum.

The radiated energy from phosphorescent material may be at a different wavelength than the excitation energy. In fact, for most phosphorescent materials, the most efficient excitation wavelength(s) may well be significantly different from the peak of the radiated energy. For example, the peak of the radiated energy may be in the red region of the visible spectrum; whereas, the peak of the excitation energy may be in the blue region of the visible spectrum or in the ultraviolet region. Such a characteristic creates both challenges and opportunities in the use of phosphorescent materials for temperature measurement.

Currently, there are two approaches to measure a temperature of phosphorescent material, which may be applied to a surface of a material whose temperature is to be measured or integrated within a material enabling the measurement of the temperature within the material.

In the first approach, a complex optical splitting and routing system is connected to an excitation emitter configured to excite the phosphorescent material at an excitation frequency as well as connected to a receiving detector configured to detect the emission from the excited phosphorescent material at an emission frequency. Unfortunately, the use of discrete devices for emission and reception requires a relatively expensive, highly complex optical assembly.

In the second approach, a single device is used as both the emitter and receiver alternating between forward powering the device to function as an emitter and reverse biasing the device to function as a photodiode receiver. While such an approach is less expensive and complex than the first approach, the second approach usually results in using a sub-optimal wavelength for both excitation and emission since one cannot select a single optimal wavelength for both excitation and emission. As discussed above, the most efficient excitation wavelength(s) may well be significantly different from the peak of the radiated energy. Hence, by using a single selected wavelength, such a selected wavelength is not optimal for either emitting or receiving. Furthermore, the second approach in using a single device has a poor signal-to-noise ratio. Consequently, the sensitivity of the system is reduced thereby requiring a complex post-processing algorithm to make use of the measured data.

Hence, there is not currently a means for effectively and efficiently measuring the temperature of phosphorescent material, which may be applied to a surface of a material whose temperature may need to be measured or integrated within a material enabling the measurement of the temperature within the material.

### SUMMARY

In one embodiment of the present disclosure, a system for measuring a temperature of phosphorescent material comprises a multiple element light emitting diode configured to measure the temperature of the phosphorescent material, where a first light emitting diode element of the multiple element light emitting diode is configured to output a first wavelength to excite the phosphorescent material. Furthermore, a second light emitting diode element of the multiple element light emitting diode is configured to detect an emission from the excited phosphorescent material at a second wavelength, where the first wavelength is at a different wavelength than the second wavelength.

In another embodiment of the present disclosure, a method for measuring a temperature of phosphorescent material comprises outputting a first wavelength from a first light emitting diode element of a multiple element light emitting diode to excite the phosphorescent material. The method further comprises detecting an emission from the excited phosphorescent material at a second wavelength by a second light emitting diode element of the multiple element light emitting diode, where the first wavelength is at a different wavelength than the second wavelength.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a system for measuring the temperature of phosphorescent material, which may be applied to the surface of a material whose temperature needs to be measured or integrated within a material enabling the measurement of the temperature within the material, in accordance with an embodiment of the present disclosure;

FIG. 2 is a graph of the absorption or emission intensity of phosphorescent material, such as magnesium fluorogermanate, with respect to wavelength in accordance with an embodiment of the present disclosure; and

FIG. 3 is a flowchart of a method for measuring the temperature of phosphorescent material, which may be applied to the surface of a material whose temperature needs to be measured or integrated within a material enabling the measurement of the temperature within the material, in accordance with an embodiment of the present disclosure.

### DETAILED DESCRIPTION

As stated above, certain phosphorescent materials show clear quantifiable changes in behavior that are related to temperature. Of particular interest is the fact that phosphorescent materials emit radiant energy in or near the visible spectrum when excited by an external energy source and will continue to radiate for a period of time after the excitation energy is removed. Such a phosphorescent effect is used in a wide range of commercial and industrial applications, such as in lighting systems.

As discussed above, when the excitation energy is removed, the luminescence will persist for a characteristic time, steadily decreasing. The time required for the brightness to decrease to 1/e (where e corresponds to Euler's number) of its original value is known as the decay time or lifetime, which is signified as τ. This decay rate has been shown to be related to temperature for certain materials, such as magnesium fluorogermanate (Mg₄FGeO₆), an example of phosphorescent material. A number of commercially available sensing and monitoring products make use of this phenomenon to sense and measure temperature in locations and environments where more traditional measurement technologies may not be usable for a variety of reasons.

The energy that is radiated from phosphorescent material is specific to the phosphor compound and is generally restricted to a very narrow wavelength range for a specific phosphor compound. Hence, the selection of the phosphorescent material determines both the energy characteristics of the system and the output wavelength or color. As an example, using magnesium fluorogermanate as the phosphorescent material, the phosphorescent material will emit a very narrow band of energy centered at 655 nm, which is in the red region of the visible spectrum.

The radiated energy from phosphorescent material may be at a different wavelength than the excitation energy. In fact, for most phosphorescent materials, the most efficient excitation wavelength(s) may well be significantly different from the peak of the radiated energy. For example, the peak of the radiated energy may be in the red region of the visible spectrum; whereas, the peak of the excitation energy may be in the blue region of the visible spectrum or in the ultraviolet region. Such a characteristic creates both challenges and opportunities in the use of phosphorescent materials for temperature measurement.

Currently, there are two approaches to measure a temperature of phosphorescent material, which may be applied to a surface of a material whose temperature is to be measured or integrated within a material enabling the measurement of the temperature within the material.

In the first approach, a complex optical splitting and routing system is connected to an excitation emitter configured to excite the phosphorescent material at an excitation frequency as well as connected to a receiving detector configured to detect the emission from the excited phosphorescent material at an emission frequency. Unfortunately, the use of discrete devices for emission and reception requires a relatively expensive, highly complex optical assembly.

In the second approach, a single device is used as both the emitter and receiver alternating between forward powering the device to function as an emitter and reverse biasing the device to function as a photodiode receiver. While such an approach is less expensive and complex than the first approach, the second approach usually results in using a sub-optimal wavelength for both excitation and emission since one cannot select a single optimal wavelength for both excitation and emission. As discussed above, the most efficient excitation wavelength(s) may well be significantly different from the peak of the radiated energy. Hence, by using a single selected wavelength, such a selected wavelength is not optimal for either emitting or receiving. Furthermore, the second approach in using a single device has a poor signal-to-noise ratio. Consequently, the sensitivity of the system is reduced thereby requiring a complex post-processing algorithm to make use of the measured data.

Hence, there is not currently a means for effectively and efficiently measuring the temperature of phosphorescent material, which may be applied to a surface of a material whose temperature may need to be measured or integrated within a material enabling the measurement of the temperature within the material.

The embodiments of the present disclosure provide a means for utilizing a dual element light emitting diode to measure the temperature of the phosphorescent material, which may be applied to a surface of the material whose temperature needs to be measured or integrated within a material enabling the measurement of the temperature within the material. In one embodiment, the dual element light emitting diode includes a first light emitting diode element configured to output a first wavelength to excite the phosphorescent material and a second light emitting diode element configured to detect an emission from the excited phosphorescent material, where the first and second wavelengths are different from each other. In one embodiment, the first wavelength corresponds to a peak absorption intensity of the phosphorescent material. In one embodiment, the second wavelength corresponds to a peak emission intensity of the phosphorescent material. In this manner, both excitation and detection are able to operate at their most efficient wavelengths while simultaneously eliminating the need for a complex optical splitting and routing system. Furthermore, in this manner, the receiving device can remain active continuously as opposed to requiring the device to alternate between excitation and detection. Furthermore, in this manner, the system of the present disclosure is less complex, less expensive, and has a higher usable sensitivity than prior approaches. A further discussion regarding these and other features is provided below.

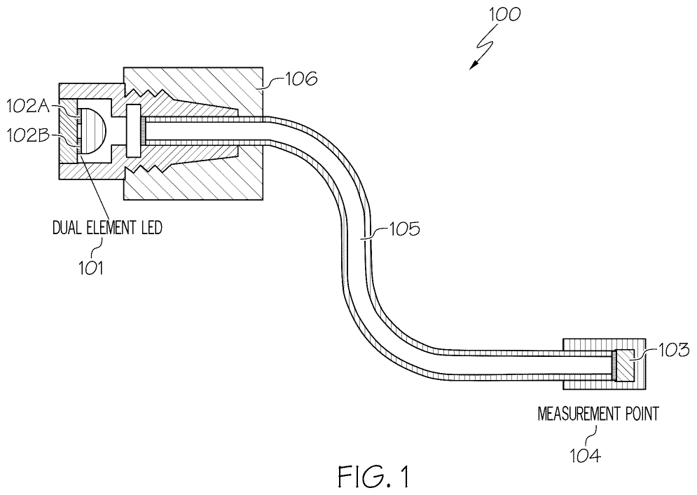

Referring now to the Figures in detail, FIG. 1 illustrates an embodiment of the present disclosure of a system 100 for measuring the temperature of phosphorescent material, which may be applied to the surface of a material whose temperature needs to be measured or integrated within a material enabling the measurement of the temperature within the material, in accordance with an embodiment of the present disclosure.

As shown in FIG. 1, system 100 includes a dual element light emitting diode (LED) 101 that includes a first light emitting diode element 102A configured to output a first wavelength to excite phosphorescent material 103 and a second light emitting diode element 102B configured to detect an emission from the excited phosphorescent material 103 at a second wavelength, where the first and second wavelengths are different from each other.

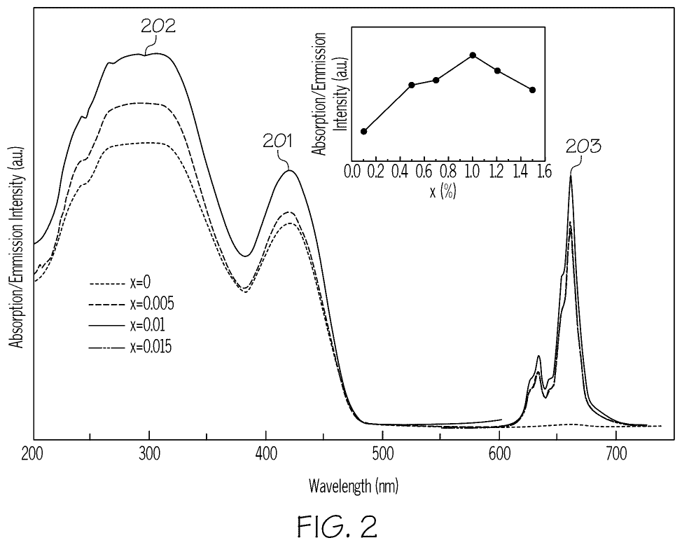

In one embodiment, the first wavelength corresponds to a peak absorption intensity of phosphorescent material 103. For example, the peak absorption intensity of phosphorescent material 103 may reside within the blue wavelength region (wavelength between 420 and 500 nanometers) for phosphorescent material 103 corresponding to magnesium fluorogermanate (Mg₄FGeO₆) as illustrated in FIG. 2.

FIG. 2 is a graph of the absorption or emission intensity of phosphorescent material 103, such as magnesium fluorogermanate, with respect to wavelength in accordance with an embodiment of the present disclosure.

As shown in FIG. 2, the peak absorption intensity of phosphorescent material 103 may reside within the blue wavelength region (wavelength between 420 and 500 nanometers), such as at 420 nm (see point 201), for phosphorescent material 103 corresponding to magnesium fluorogermanate.

As also shown in FIG. 2, there is another peak absorption intensity of phosphorescent material 103 in the ultraviolet region, such as at point 202. While the following discussion regarding measuring the temperature of phosphorescent material 103 focuses on utilizing the peak intensity of phosphorescent material 103 in the visible spectrum, the principles of the present disclosure may also be applied to utilizing the peak intensity of phosphorescent material 103 in the ultraviolet region. A person of ordinary skill in the art would be capable of applying the principles of the present disclosure to such implementations. Furthermore, embodiments applying the principles of the present disclosure to such implementations would fall within the scope of the present disclosure.

Returning to FIG. 1, in conjunction with FIG. 2, in one embodiment, the second wavelength corresponds to a peak emission intensity of phosphorescent material 103. For example, the peak emission intensity of phosphorescent material 103 may reside within the red wavelength region (wavelength between 625 and 740 nanometers) for phosphorescent material 103 corresponding to magnesium fluorogermanate.

As shown in FIG. 2, the peak emission intensity of phosphorescent material 103 may reside within the red wavelength region (wavelength between 625 and 740 nanometers), such as at 655 nm (see point 203), for phosphorescent material 103 corresponding to magnesium fluorogermanate.

Returning again to FIG. 1, in one embodiment, phosphorescent material 103 is applied to a surface of a material whose temperature may need to be measured, such as at measurement point 104. An example of phosphorescent material 103 is magnesium fluorogermanate. In one embodiment, phosphorescent material 103 is integrated in a material, such as being integrated in a thermal barrier coating, thereby enabling the measurement of the temperature within the material.

In one embodiment, an optical fiber 105 is used to connect dual element light emitting diode 101 to phosphorescent material 103 at measurement point 104 via connector 106. An example of optical fiber 105 used to connect dual element light emitting diode 101 to phosphorescent material 103 at measurement point 104 includes, but not limited to, FT400UMT by Thorlabs®.

In one embodiment, the rate of decay of the detected emission is used to measure the temperature of phosphorescent material 103. For example, when the excitation energy is removed by first light emitting diode element 102A ceasing operation, the luminescence of phosphorescent material 103 will persist for a characteristic time, steadily decreasing. The time required for the brightness to decrease to 1/e (where e corresponds to Euler's number) of its original value is known as the decay time or lifetime, which is signified as τ. This decay rate has been shown to be related to temperature for certain materials, such as magnesium fluorogermanate (Mg₄FGeO₆), an example of phosphorescent material 103.

By using dual element light emitting diode (LED) 101 for measuring a temperature of phosphorescent material 103, both light emitting diode elements (e.g., light emitting diode elements 102A, 102B) for excitation and detection are able to operate at their most efficient wavelengths. Furthermore, by utilizing system 100, the need for a complex optical splitting and routing system is eliminated. Furthermore, by utilizing system 100, the light emitting diode element (e.g., light emitting diode element 102B) operable for detecting the emission from the exited phosphorescent material 103 can remain active continuously as opposed to requiring the single device to alternate between excitation and detection. Furthermore, the system of the present disclosure is less complex, less expensive, and has a higher usable sensitivity than prior approaches.

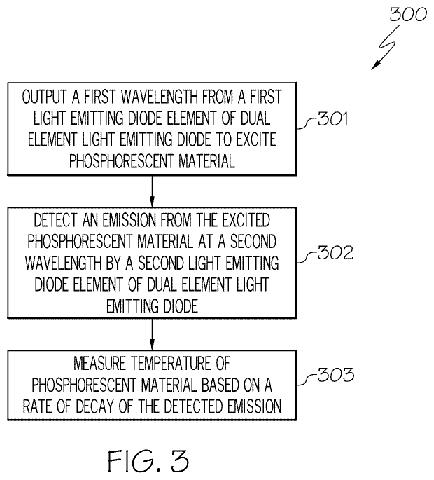

A further description of these and other features is provided below in connection with the discussion of the method of FIG. 3 for measuring the temperature of phosphorescent material, which may be applied to the surface of a material whose temperature needs to be measured.

FIG. 3 is a flowchart of a method 300 for measuring the temperature of phosphorescent material, which may be applied to the surface of a material whose temperature needs to be measured or integrated within a material enabling the measurement of the temperature within the material, in accordance with an embodiment of the present disclosure.

Referring now to FIG. 3, in conjunction with FIGS. 1-2, in step 301, a first wavelength is outputted from a first light emitting diode element 102A of dual element light emitting diode 101 to excite phosphorescent material 103.

As discussed above, duale element light emitting diode 101 is configured to measure a temperature of phosphorescent material 103, which may be applied to the surface of a material whose temperature needs to be measured or integrated within a material enabling the measurement of the temperature within the material.

In one embodiment, the first wavelength corresponds to a peak absorption intensity of phosphorescent material 103. For example, the peak absorption intensity of phosphorescent material 103 may reside within the blue wavelength region (wavelength between 420 and 500 nanometers) for phosphorescent material 103 corresponding to magnesium fluorogermanate (Mg₄FGeO₆).

In step 302, an emission from the excited phosphorescent material 103 is detected at a second wavelength by a second light emitting diode element 102B of dual element light emitting diode 101, where the first and second wavelengths are different.

As stated above, in one embodiment, the second wavelength corresponds to a peak emission intensity of phosphorescent material 103. For example, the peak emission intensity of phosphorescent material 103 may reside within the red wavelength region (wavelength between 625 and 740 nanometers) for phosphorescent material 103 corresponding to magnesium fluorogermanate.

In one embodiment, phosphorescent material 103 is applied to the surface of a material whose temperature needs to be measured, such as at measurement point 104. An example of phosphorescent material 103 is magnesium fluorogermanate. In one embodiment, phosphorescent material 103 is integrated in a material, such as being integrated in a thermal barrier coating, thereby enabling the measurement of the temperature within the material.

In one embodiment, the first and second wavelengths are outputted and detected, respectively, via an optical fiber 105, which is used to connect dual element light emitting diode 101 to phosphorescent material 103 at measurement point 104 via connector 106. An example of optical fiber 105 used to connect dual element light emitting diode 101 to phosphorescent material 103 at measurement point 104 includes, but not limited to, FT400UMT by Thorlabs®.

In step 303, the temperature of phosphorescent material 103 is measured based on a rate of decay of the detected emission.

As discussed above, in one embodiment, the rate of decay of the detected emission is used to measure the temperature of phosphorescent material 103. For example, when the excitation energy is removed by first light emitting diode element 102A ceasing operation, the luminescence of phosphorescent material 103 will persist for a characteristic time, steadily decreasing. The time required for the brightness to decrease to 1/e (where e corresponds to Euler's number) of its original value is known as the decay time or lifetime, which is signified as τ. This decay rate has been shown to be related to temperature for certain materials, such as magnesium fluorogermanate (Mg₄FGeO₆), an example of phosphorescent material 103.

As a result of the foregoing, the principles of the present disclosure provide a means for measuring the temperature of the phosphorescent material, which may be applied to the surface of the material whose temperature needs to be measured or integrated within a material enabling the measurement of the temperature within the material, more efficiently and effectively. For example, by using a dual element light emitting diode (LED) for excitation and detection, both excitation and detection are able to operate at their most efficient wavelengths.

Furthermore, the system of the present disclosure eliminates the need for a complex optical splitting and routing system.

Additionally, by utilizing the system of the present disclosure, the light emitting diode element operable for detecting the emission from the exited phosphorescent material can remain active continuously as opposed to requiring the single device to alternate between excitation and detection.

Furthermore, the system of the present disclosure is less complex, less expensive, and has a higher usable sensitivity than prior approaches.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for measuring a temperature of phosphorescent material, the system comprising:
a multiple element light emitting diode configured to measure said temperature of said phosphorescent material, wherein a first light emitting diode element of said multiple element light emitting diode is configured to output a first wavelength to excite said phosphorescent material, wherein a second light emitting diode element of said multiple element light emitting diode is configured to detect an emission from said excited phosphorescent material at a second wavelength, wherein said first wavelength is at a different wavelength than said second wavelength. 8

2. The system as recited in claim 1 further comprising:
an optical fiber connecting said multiple element light emitting diode to said phosphorescent material at a measurement point.

3. The system as recited in claim 1, wherein a rate of decay of said detected emission is used to measure said temperature of said phosphorescent material.

4. The system as recited in claim 1, wherein said first light emitting diode element is configured to output said first wavelength corresponding to a peak absorption intensity of said phosphorescent material.

5. The system as recited in claim 1, wherein said first light emitting diode element is configured to output said first wavelength in a blue wavelength region.

6. The system as recited in claim 5, wherein said blue wavelength region corresponds to a wavelength between 420 and 500 nanometers.

7. The system as recited in claim 1, wherein said second light emitting diode element is configured to detect said emission from said excited phosphorescent material at said second wavelength corresponding to a peak emission intensity of said phosphorescent material.

8. The system as recited in claim 1, wherein said second light emitting diode element is configured to detect said emission from said excited phosphorescent material at said second wavelength in a red wavelength region.

9. The system as recited in claim 8, wherein said red wavelength region corresponds to a wavelength between 625 and 740 nanometers.

10. The system as recited in claim 1, wherein said phosphorescent material comprises magnesium fluorogermanate.

11. A method for measuring a temperature of phosphorescent material, the method comprising:
outputting a first wavelength from a first light emitting diode element of a multiple element light emitting diode to excite said phosphorescent material; and
detecting an emission from said excited phosphorescent material at a second wavelength by a second light emitting diode element of said multiple element light emitting diode, wherein said first wavelength is at a different wavelength than said second wavelength.

12. The method as recited in claim 11, wherein an optical fiber connects said multiple element light emitting diode to said phosphorescent material at a measurement point.

13. The method as recited in claim 11 further comprising:
measuring said temperature of said phosphorescent material based on a rate of decay of said detected emission.

14. The method as recited in claim 11, wherein said first wavelength corresponds to a peak absorption intensity of said phosphorescent material.

15. The method as recited in claim 11, wherein said first wavelength corresponds to a wavelength in a blue wavelength region.

16. The method as recited in claim 15, wherein said blue wavelength region corresponds to a wavelength between 420 and 500 nanometers.

17. The method as recited in claim 11, wherein said second wavelength corresponds to a peak emission intensity of said phosphorescent material.

18. The method as recited in claim 11, wherein said second wavelength corresponds to a wavelength in a red wavelength region.

19. The method as recited in claim 18, wherein said red wavelength region corresponds to a wavelength between 625 and 740 nanometers.

20. The method as recited in claim 11, wherein said phosphorescent material comprises magnesium fluorogermanate.
